(19) United States
(12) Patent Application Publication
(10) Pub. No.: US 2001/0051981 A1
(43) Pub. Date: Dec. 13, 2001

(54) Methods and systems for discovering object-exchange resources on a network

(75) Inventors: Eric W. Davison, Seattle, WA (US); Daniel R. Weisman, Kirkland, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA (US)

(21) Appl. No.: 09/872,222

(22) Filed: Jun. 1, 2001

Related U.S. Application Data
(63) Continuation-in-part of application No. 09/587,753, filed on Jun. 5, 2000.

(51) Int. Cl. G06F 15/16; G06F 9/00; G06F 9/46

(52) U.S. Cl. 709/203; 709/245; 709/316

(57) ABSTRACT

A method for an object-exchange client device to discover network resources is disclosed. Clients listen on well-known communications channels of routable network protocols for advertisements identifying accessible resources. Clients use the information in the advertisements to determine which resources are available and when they become unavailable. In addition, clients send discovery requests over well-known communications channels requesting accessible resources to respond by identifying themselves. When a new resource becomes available, it advertises itself on a common communications channel. The client can specify criteria in its discovery request and only resources meeting those criteria are expected to respond. In particular, the client can limit the scope of dispersion of a discovery request to one network hop or to a certain geographical or network topological region. The scope can be expanded by propagating the request to other networks by means of a bridging protocol.

### RELATED APPLICATION

This application is a continuation-in-part of U.S. patent application Ser. No. 09/587,753, filed Jun. 5, 2000.

### TECHNICAL FIELD

This invention relates generally to computer communications, and, more particularly, to methods and mechanisms for discovering computer resources on a network.

### BACKGROUND OF THE INVENTION

To provide useful services to their users, small computing devices (here called clients) often depend upon outside resources, such as services provided by remote and more powerful servers. This is especially true when the client device can provide only limited utility by itself or when the client device is mobile. Such client devices include palmtop computers, mobile telephones/browsers, pagers, etc.

Before a client device can use a resource, the client must know how to contact the server. Traditionally, server contact information is configured into the client. However, pre-configuring the client does not work well in today's rapidly changing networks. Static configuration data quickly become outdated as servers change, new services are offered, and the client's needs change. Compounding the problem, small clients are rarely administered by expert personnel who can keep up with changes in the network environment. To address this problem, special servers called “directory servers” have been created that contain directories of information on how to contact other servers. A client need only be configured to find a directory server, and, using information returned from the directory server, the client can then contact any other server.

Even directory servers fail to work when the client device becomes mobile. In that case, the set of servers, directory or otherwise, available to the client is in constant flux as the client moves around and as its transmission signals are subjected to various forms of interference. Over short-range wireless connections (such as IrDA or Bluetooth), mechanisms have been developed that allow a client running an object-exchange protocol to broadcast a message asking for the servers within range of its signal to announce their presence. However, there are times when an object-exchange client has access to a routable network connection and needs to discover which resources are available to it via the routable network protocol. The methods developed for short-range wireless connections do not work for routable network protocols that can, in theory, encompass the entire world. Neither would configuring the object-exchange client for a directory server provide the answer because the client's mobility means that it may be constantly connecting to different networks, wired or wireless, and may be constantly in need of different directory servers.

Ideally, an object-exchange client device should always be able to discover the resources that are available to it at the time it needs to contact them, regardless of whether the resources are accessible via a short-range wireless protocol or a routable network protocol.

### SUMMARY OF THE INVENTION

The above problems and shortcomings, and others, are addressed by the present invention, which can be understood by referring to the specification, drawings, and claims. The invention is a method for an object-exchange client device to discover network resources. Clients listen on well-known communications channels of routable network protocols for advertisements identifying accessible resources. Clients use the information in the advertisements to determine which resources are available and when they become unavailable. In addition, clients send discovery requests over well-known communications channels requesting accessible resources to respond by identifying themselves. When a new resource becomes available, it advertises itself on a common communications channel.

The client can specify criteria in its discovery request and only resources meeting those criteria are expected to respond. In particular, the client can limit the scope of dispersion of a discovery request to one network hop or to a certain geographical or network topological region. The scope can be expanded by propagating the request to other networks by means of a bridging protocol.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a network diagram showing an object-exchange client communicating with two object-exchange servers;

FIG. 2 is a block diagram generally illustrating an exemplary computer system that supports the present invention;

FIG. 3 is a flowchart illustrating one way an object-exchange application can communicate over a network independently of the underlying transport provider;

FIG. 4 is a block diagram illustrating an embodiment of an object-exchange service that directs data through a plurality of transport providers;

FIG. 5 is a block diagram adding details to FIG. 4 to illustrate how specific object-exchange services may use different transport providers;

FIG. 6 is a flowchart summarizing the operation of an object-exchange inbox service;

FIGS. 7A through 7D are network diagrams illustrating the scope of object-exchange resource discovery requests;

FIG. 8 is a flowchart illustrating the advertisement method of discovering object-exchange resources; and

FIG. 9 is a flowchart illustrating the solicitation method of discovering object-exchange resources.

### DETAILED DESCRIPTION OF THE INVENTION

Turning to the drawings, wherein like reference numerals refer to like elements, the invention is illustrated as being implemented in a suitable computing environment. The following description is based on embodiments of the invention and should not be taken as limiting the invention with regard to alternative embodiments that are not explicitly described herein. The first section describes object-exchange protocols and resources. Section II describes how the present invention is used for discovering object-exchange resources on a network.

In the description that follows, the invention is described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that various of the acts and operations described hereinafter may also be implemented in hardware.

### I. Object-Exchange Protocols and Resources

As a prelude to Section II's description of how the present invention discovers object-exchange resources on a network, this section presents information on object-exchange protocols and resources. This section is based upon U.S. patent application Ser. No. 09/587,753, “Transport Independent OBEX Implementation,” incorporated herein by reference including any tables, appendices, or other publications referenced therein.

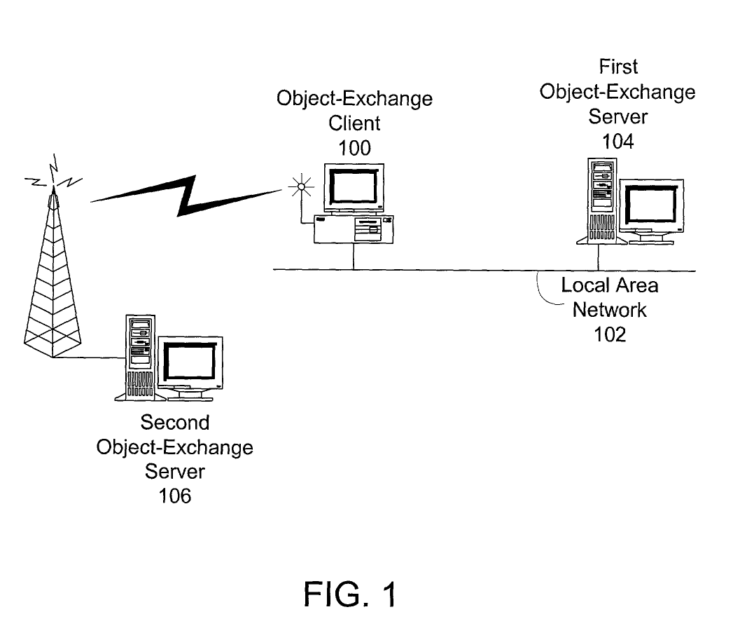

FIG. 1 is a network diagram showing an object-exchange client 100 communicating with two object-exchange servers 104 and 106. The client and servers use object-exchange protocols to transfer “objects” among themselves. In this context, “objects” are very broadly defined as sets of digital data. Object-exchange protocols are unconcerned with the specific syntax and semantics of the objects transferred. Objects may be exchanged over any type of communications medium. For example, the client 100 communicates with the first object-exchange server 104 via a wired LAN 102 and uses radio to communicate with the second object-exchange client 106.

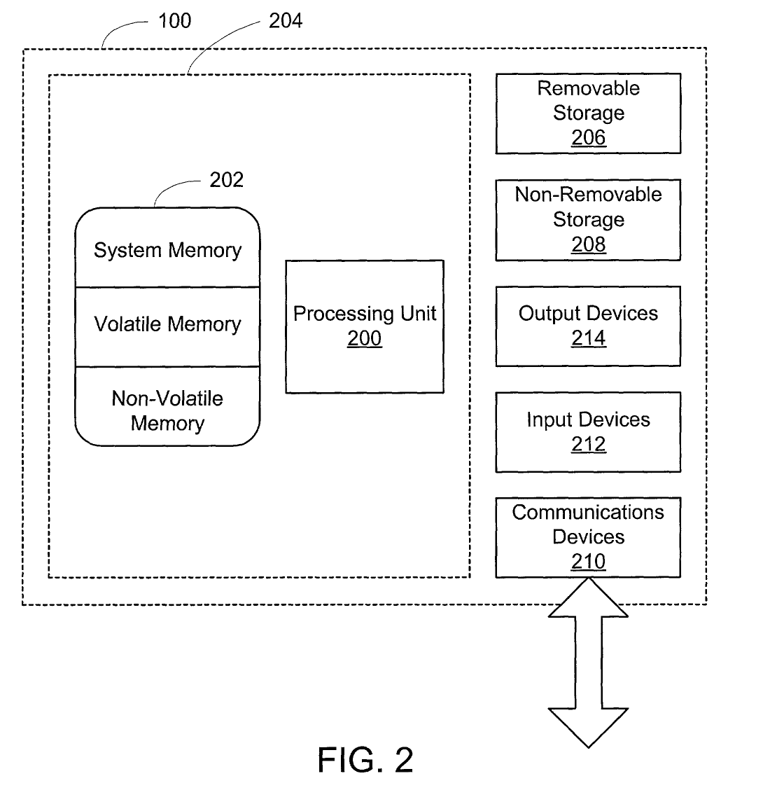

While object-exchange clients are often hand-held devices, the object-exchange client 100 and servers 104 and 106 of FIG. 1 may be of any architecture. FIG. 2 is a block diagram generally illustrating an exemplary computer system that supports the present invention. The computing device 100 is only one example of a suitable environment and is not intended to suggest any limitation as to the scope of use or functionality of the invention. Neither should the computing device 100 be interpreted as having any dependency or requirement relating to any one or combination of components illustrated in FIG. 2. The invention is operational with numerous other general-purpose or special-purpose computing environments or configurations. Examples of well-known computing systems, environments, and configurations suitable for use with the invention include, but are not limited to, personal computers, servers, hand-held or laptop devices, multiprocessor systems, microprocessor-based systems, set-top boxes, programmable consumer electronics, network PCs, minicomputers, mainframe computers, and distributed computing environments that include any of the above systems or devices. In its most basic configuration, computing device 100 typically includes at least one processing unit 200 and memory 202. The memory 202 may be volatile (such as RAM), non-volatile (such as ROM, flash memory, etc.), or some combination of the two. This most basic configuration is illustrated in FIG. 2 by the dashed line 204. The computing device may have additional features and functionality. For example, computing device 100 may include additional storage (removable and non-removable) including, but not limited to, magnetic and optical disks and tape. Such additional storage is illustrated in FIG. 2 by removable storage 206 and non-removable storage 208. Computer-storage media include volatile and non-volatile, removable and non-removable, media implemented in any method or technology for storage of information such as computer-readable instructions, data structures, program modules, or other data. Memory 202, removable storage 206, and non-removable storage 208 are all examples of computer-storage media. Computer-storage media include, but are not limited to, RAM, ROM, EEPROM, flash memory, other memory technology, CD-ROM, digital versatile disks (DVD), other optical storage, magnetic cassettes, magnetic tape, magnetic disk storage, other magnetic storage devices, and any other media which can be used to store the desired information and which can accessed by device 100. Any such computer storage media may be part of device 100. Device 100 may also contain communications connections 210 that allow the device to communicate with other devices. Communications connections 210 are examples of communications media. Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media, such as wired networks (including the LAN 102 of FIG. 1) and direct-wired connections, and wireless media such as acoustic, RF, infrared, and other wireless media. The term computer-readable media as used herein includes both storage media and communications media. The computing device 100 may also have input devices 212 such as a keyboard, mouse, pen, voice-input device, touch-input device, etc. Output devices 214 such as a display, speakers, printer, etc., may also be included. All these devices are well know in the art and need not be discussed at length here.

The concepts of object-exchange protocols are illustrated with reference to OBEX, an example of such a protocol. Similar to the Hypertext Transfer Protocol, OBEX is a lighter protocol based on a client/server model. OBEX consists of a protocol and an application framework. The application framework is built on top of the protocol and is used to ensure interoperability among devices and applications using OBEX. The protocol consists of a format for communication among devices and applications and a set of communications functions. The functions include discovering available resources (servers and services), initiating a connection to a resource, disconnecting a connection, sending an object from a client to a server, and requesting that a server return an object to a client. Resource discovery is the subject of Section II.

OBEX operates over a variety of transport mechanisms, for example, the Internet Protocol (IP), the Infrared Data Association's IrDA, and Bluetooth short-range radio. Applications and devices need transport-specific information before using a particular transport. A transport-independent layer allows OBEX applications to operate without regard to the transport mechanism used. In a Microsoft “WINDOWS” implementation of OBEX, the transport-independent layer can be a dynamic link library and the Windows registry, or another data store, can store transport-specific data read at start-up.

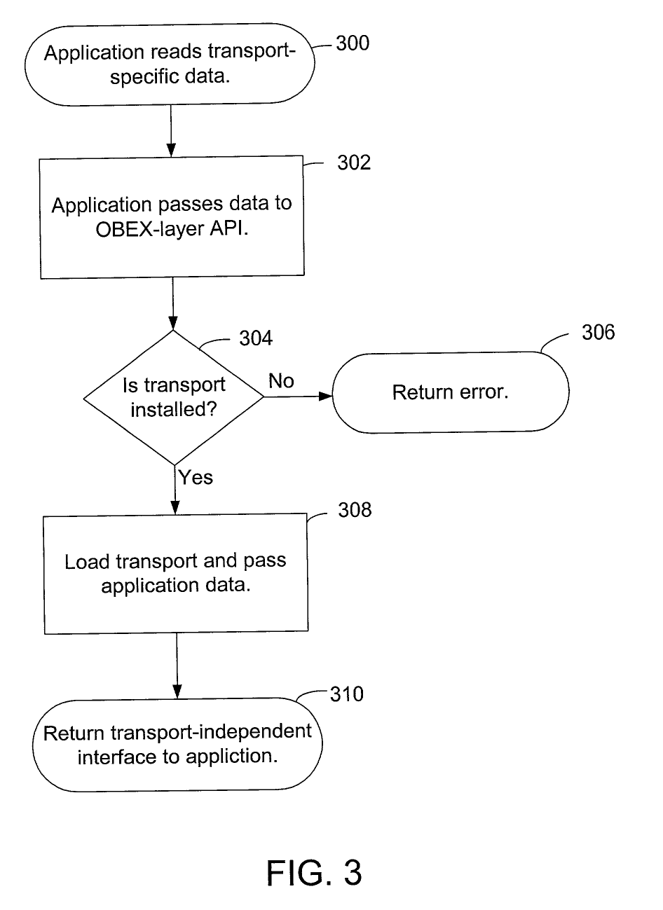

FIG. 3 is a flowchart illustrating one way an object-exchange application can communicate over a network independently of the underlying transport provider. During steps 300 and 302, an application programming interface (API) allows OBEX applications to pass transport-specific data to the OBEX layer to initialize the networking subsystem. The data have a pre-defined format so that in step 304 the OBEX layer can determine for which transport the data are intended. If that transport is not installed, an error message is returned in step 306. If the transport is installed, then control passes from step 304 to step 308 wherein the OBEX layer creates the appropriate transport module and passes the transport-specific data down to that module. During step 310, the OBEX layer returns a transport-independent interface to the application to use whenever it communicates on the network.

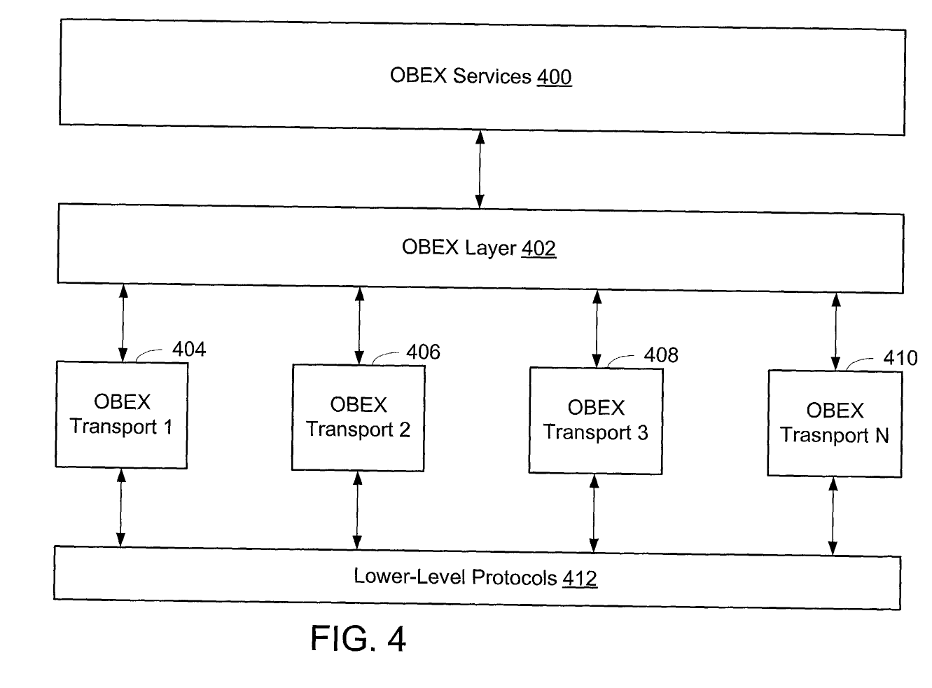

FIG. 4 is a block diagram illustrating an embodiment of an object-exchange service that directs data through a plurality of transport providers. In this embodiment, initialization data are read at setup time from a device information file. The OBEX services 400 reside on top of the OBEX layer 402. The OBEX layer allocates packets and posts them down to the transport providers 404, 406, 408, and 410. When an incoming data packet is received, the OBEX layer determines which OBEX service should be notified of the data, abstracts the data, and provides the data to the correct OBEX service. Outgoing data passed to the OBEX layer from the OBEX services may not be in the correct protocol format for the transport used. The OBEX layer generates outbound packets with correct headers for the transport protocol used and sends the outbound packets down to the appropriate transport provider.

Each transport provider defines the layout of its initialization file and provides a small application to convert that file so that the application can pass its contents through the OBEX layer 402. In one Microsoft “WINDOWS” embodiment, application transport-specific data are stored in the registry and can be read at startup time. When a new transport is brought on-line, it is registered so that the OBEX layer knows about it. For an application to support a new transport, the application reads data from the registry and passes it through the OBEX APIs. In this manner, the application need not know which transport it is using.

Enumeration of OBEX devices is done at the OBEX layer 402 and information about communicating OBEX clients is passed to applications in a generic fashion. Applications can display these as choices to the user for selection. The transport providers 404, 406, 408, and 410 are enumerated and presented to the user without disclosing details of the providers. When an OBEX client desires to connect to a remote device, it uses the information presented by the OBEX layer.

OBEX server applications initialize their transport information by reading data from the registry. At installation time the registry is configured with all necessary information to initialize the transport providers 404, 406, 408, and 410. The transport providers communicate with other applications through Lower-Level Protocols 412, which in some implementations may be accessed through the “WINDOWS” Sockets provider (Winsock). The transport providers discover resources and send and receive data across a network medium. The Lower-Level Protocols can be implemented by a kernel driver and a set of user-mode dynamic link libraries. They allow applications to communicate with other applications and resources via protocols such as TCP/IP, Bluetooth, and IrDA.

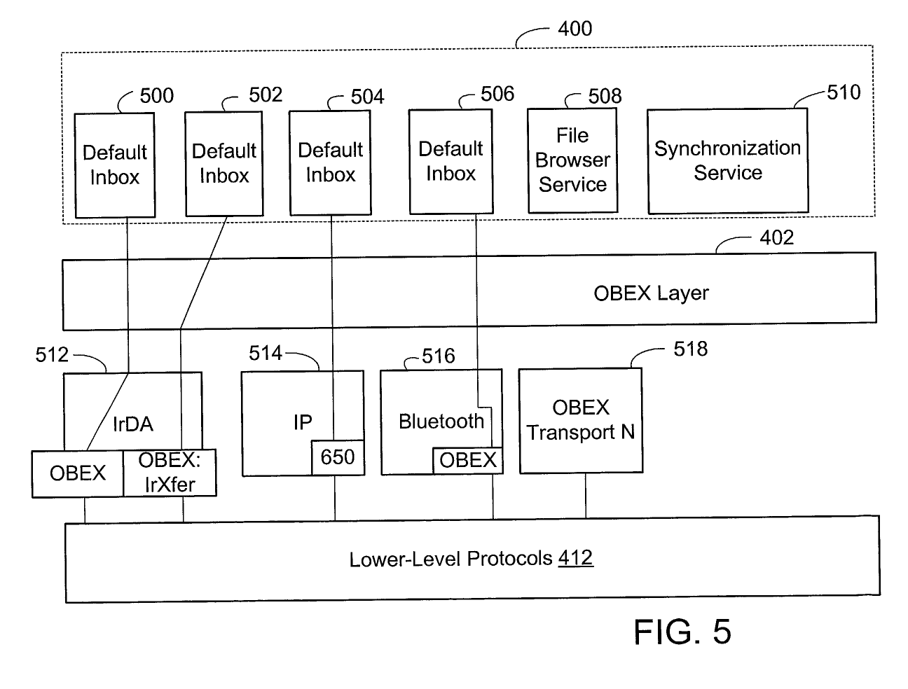

FIG. 5 is a block diagram adding details to FIG. 4 to illustrate how specific object-exchange services use different transport providers. OBEX services 400 include several default services including default inboxes 500, 502, 504, and 506 and the file browser 508. A default inbox allows a sending device to send a file or an object to a receiving device without knowing the folder hierarchy of the receiving device. A client sends a file to a server and the server is responsible for placing the file object in the correct location. The functionality provided by each default inbox may be the same, but each instance listens on a different combination of transport provider and port. For example, the default inbox 500 listens on an OBEX port of an IrDA transport 512 while the default inbox 502 listens on an OBEX:IrXfer port of the same transport. The default inbox 504 listens on the well-known port 650 of an IP transport 514 and the default inbox 506 listens on an OBEX port of a Bluetooth transport 516. The file browser service 508 allows a client to browse folders on a device and to put objects into and get objects out of the folders. The synchronization service 510 synchronizes data shared among devices such as contact data, calendars, and e-mail. The file browser and synchronization services use the same ports as the default inboxes.

OBEX may be implemented in numerous ways. Some implementations present OBEX services to applications by means of one or more APIs. An example of one API illustrates how applications and OBEX services work together. In this particular implementation, IOBEX is the main interface to OBEX services. IOBEX contains a set of functions preferably including EnumTransports, RegisterService, and EnumDevices. EnumTransports returns a pointer to ITransportEnum that is used to enumerate the known transports. ITransportEnum enumerates transport property bag interfaces. Each transport property bag interface has a globally unique identifier associated with it and a list of properties for that transport. An OBEX service that wishes to register can use this list of services to determine what should be configured for a particular transport. The transport property bag interface is then passed to the RegisterService function once all of the properties are set. RegisterService takes the transport property bag containing the properties set by the user and configures the service. EnumDevices returns an IDeviceEnum interface used to walk the list of devices within range.

Another part of this exemplary API, the IOBEXService interface listens for incoming connections and closes instances of an OBEX service. This interface contains a set of functions preferably including GetConnection, Close, and SetPassword. GetConnection listens for incoming connections for a service. It polls for incoming connections or waits until an advertisement for a service is received. Close shuts down a particular instance of an OBEX service. SetPassword assigns a password that must be used when accessing a service.

The IOBEXServiceConnection interface is used after a connection is made. This interface contains a set of functions preferably including Accept, Close, GetCommand, and EnumProperties. Accept accepts an incoming connection. Close closes the current connection and sends a disconnect request to the client. GetCommand listens for incoming command requests from the client. It either polls for an incoming command or blocks and waits for a command. EnumProperties gets the properties of a connection. It returns a set of properties that specifies client information. The caller uses this information along with header information to determine whether to accept a connection. SendResponse is used for commands that do not have data associated with them and only require a response from the server.

The IOBEXDevice interface is returned by the EnumDevices function of IOBEX. It exposes a property bag that includes standard properties such as Name, Address, and Transport which define the device. The address is transport specific. This interface contains a set of functions preferably including Connect, Put, Get, Abort, SetPath, and Disconnect. Connect connects to a specified device and operates in blocking mode. A password for the device can be specified. If a password is not specified and the server requires one, a callback is made to the interface registered on the main OBEX object. Put sends the passed-in object to the server. The user uses the IHeaderCollection interface to build a collection of headers that describes the object. Get requests an object from an OBEX server. An IHeaderCollection interface is passed in to describe the object. Get returns an IStream interface with which the user can read the incoming data. Abort sends an abort request to the server. SetPath issues a SetPath command to the server. Disconnect disconnects a specified connection.

The IOBEXTransport interface is used by the OBEX layer 402 to communicate with the transport providers 404, 406, 408, and 410. This interface contains a set of functions preferably including Init, CreateSocket, EnumDevices, EnumProperties, and Shutdown. Init initializes a transport. CreateSocket creates a socket used for listening for or connecting to other devices. There are two versions of CreateSocket. The first version takes an information package passed in by the user. The data in the information package is defined by the transport and can be unknown to the OBEX layer. The OBEX layer passes the information to the correct transport provider. The second version of CreateSocket takes a collection of properties necessary to create a listening socket. EnumDevices returns an enumeration of property collections; each collection defines a device of a specified type. When a connection to a device is made, the collection of properties that defines the device is passed in. EnumProperties returns an enumeration of the properties required to create a listening socket on the transport. The collection can then be passed through the RegisterService function and down through the CreateSocket function to create a listening socket. Shutdown closes a transport.

The IOBEXTransportSocket interface listens for incoming connections and connects to other devices. This interface contains a set of functions preferably including Close, Listen, Connect, and EnumProperties. Close closes the socket. An OBEX server uses Listen to listen on a port for incoming connection. Connect connects to another device. EnumProperties returns information about the socket.

The IOBEXTransportConnection interface provides functions that allow an application to read and write to a connection and to find out what is on the other end of a connection. This interface contains a set of functions preferably including Close, Write, Read, and EnumProperties. Close closes the connection. Write sends data on the connection. Read receives data on the connection. EnumProperties returns information about the connection.

The IOBEXSink interface is a callback interface queried on the Advise calls of the IOBEX interface. This interface contains a set of functions preferably including Notify. Notify is called whenever there is an event. Events through this interface can query the application for a password on a connection. Client events include disconnect, abort, new device list available, and query password. Server events include disconnect, abort, query password, incoming connection, and incoming command. New device is a transport event.

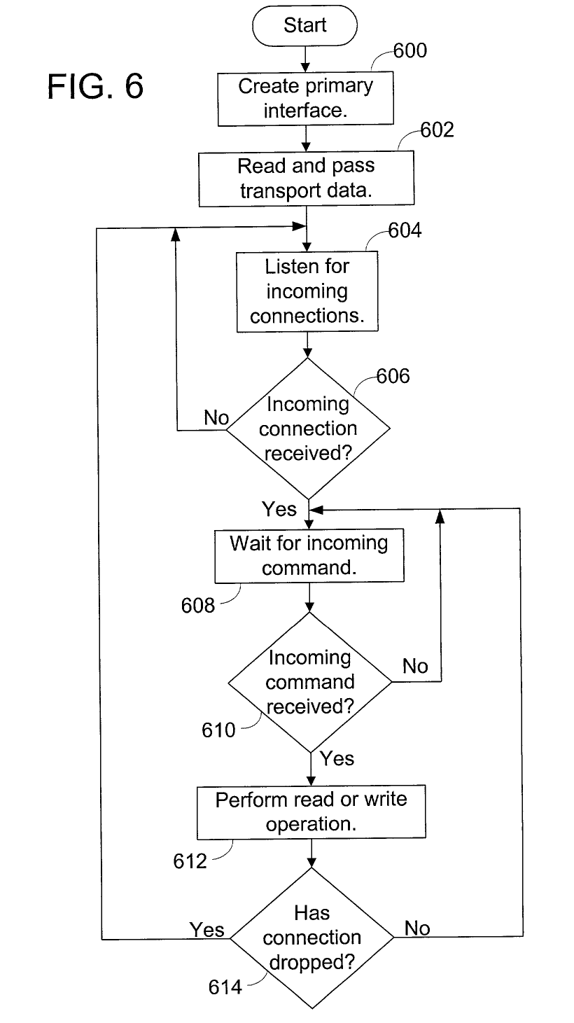

FIG. 6 is a flowchart showing how an object-exchange inbox service can operate using the API described above. Inbox services 500, 502, 504, and 506 are created using the API. During step 600, the primary interface IOBEX is created and the transport data are read from the registry. The transport data are passed to the RegisterService function which returns an IOBEXService interface in step 602. During step 604, GetConnection is called to listen for incoming connections. When an incoming connection is received, the IOBEXServiceConnection interface is returned and Accept is called to accept the incoming connection in step 606. The properties and headers of the connection are queried to find out more about the connection request and the device requesting the connection. During step 608, GetCommand is called to wait for an incoming command. When an incoming command is received, a command structure is returned in step 610. The command structure describes the command and provides a stream in which data can be received from the client or sent to the client. A read or write operation is performed in step 612 in response to receiving an incoming command. The stream is released and GetCommand is called to wait for an incoming command. If the connection is dropped, GetCommand returns an appropriate error. If the connection is lost, then during step 614 IOBEXServiceConnection interface is released and GetConnection is called to wait for incoming connections.

### II. Discovering Object-Exchange Resources on a Network

This section discloses methods for discovering resources available on a network, specifically when the network uses a routable protocol. The transport-independent OBEX API discussed above is designed to hide details of methods such as this one. The results are reported to OBEX services and applications through that API but the invention is also practiced separately from an API. Although the API given above is designed to support the OBEX protocol, the invention is applicable to object-exchange protocols besides OBEX.

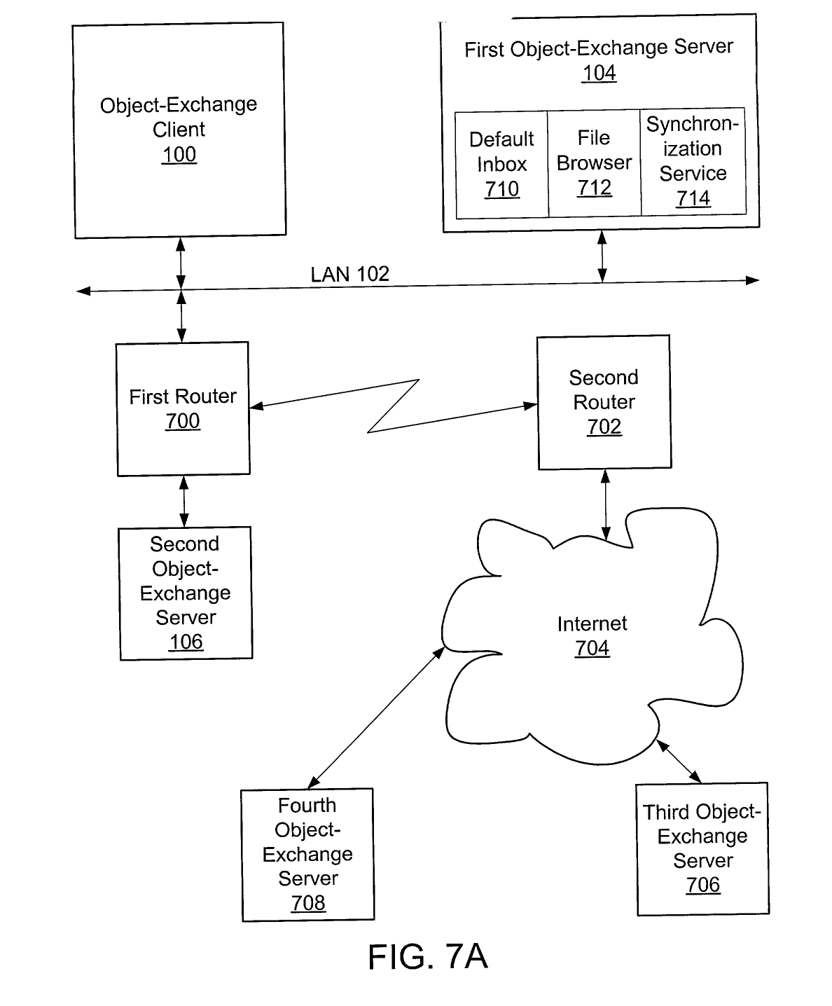

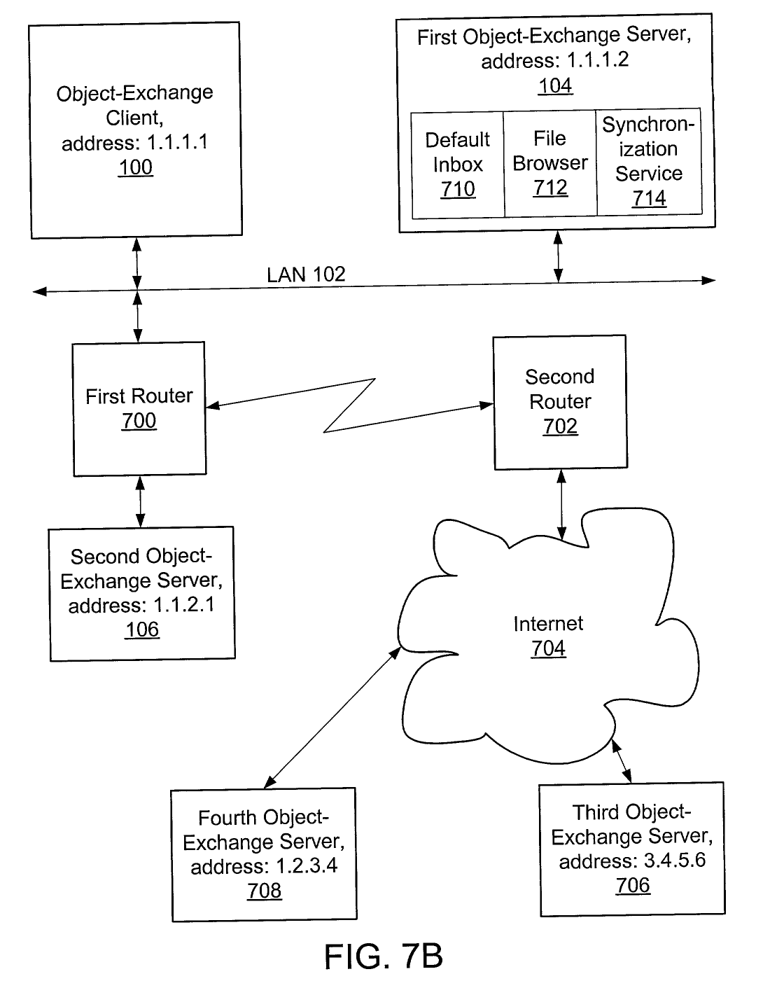

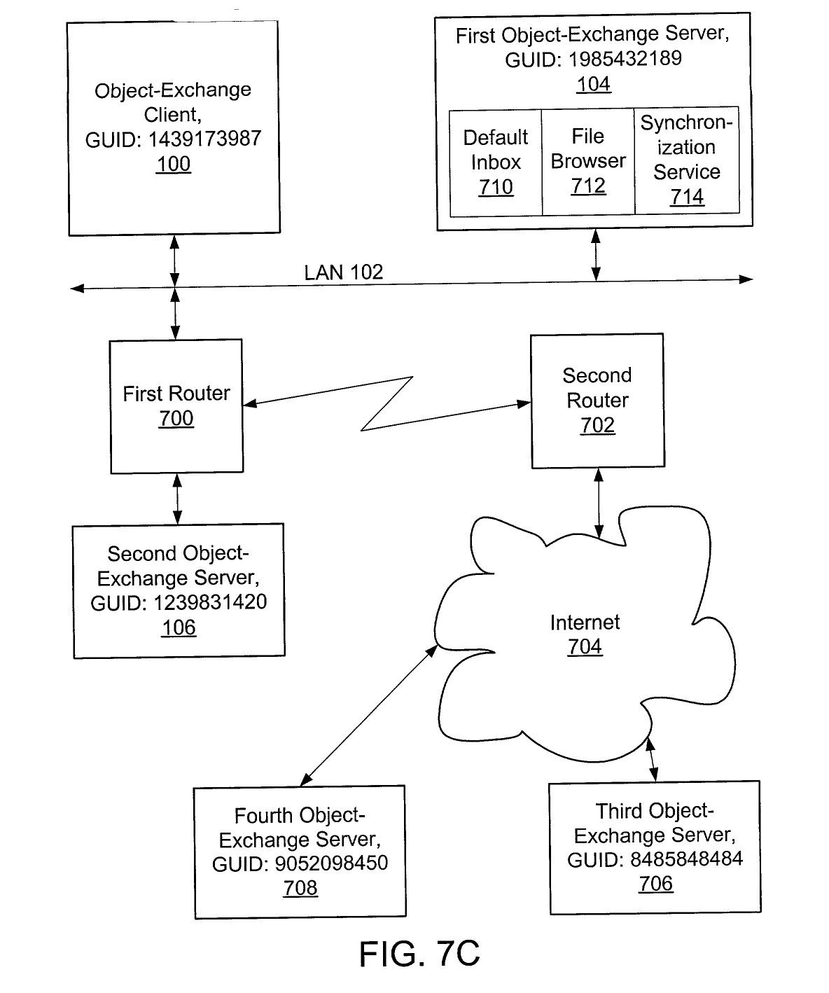

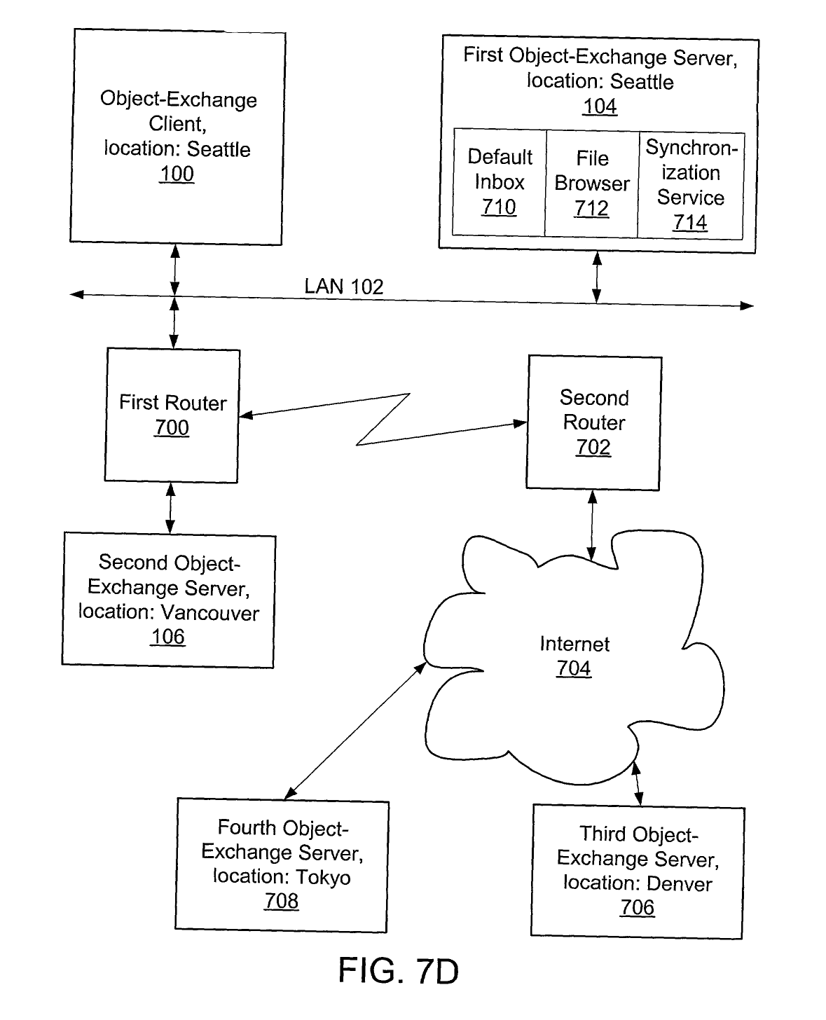

FIG. 7A is a network diagram illustrating an object-exchange client and object-exchange resources (servers and services) which may be useful to the client. The object-exchange client 100 is connected to a LAN 102, as is the first object-exchange server 104. The LAN connects to a first router 700 which in turn connects both to a second object-exchange server 106 and to a second router 702. The client and the servers are running network-routable protocols (such as IP) so that they can communicate with each other across routers if necessary. Communications to and from the Internet 704 pass through the second router. Also connected to the Internet are a third server 706 and a fourth server 708. The first server 104 is shown as providing some of the object-exchange services mentioned above, such as a default inbox 710, a file browser 712, and a synchronization service 714. The other servers, and the client, provide a similar or different set of services (not shown here for clarity's sake). Note that the labels “client” and “server” are specific to a single communications task: by definition, a “server” provides services to a “client.” In another communications task the roles may be reversed with, for example, the fourth server 708 requesting services from the client 100.

The object-exchange client 100 needs to use the services provided by one or more of the object-exchange servers 104, 106, 706, and 708 but the client is not configured with information about how to access these servers. This may be due to the fact that the client or the servers move around so much that any stored information quickly becomes out-of-date. It may be due to the fact that the client (which may be a simple portable telephone) does not possess the internal resources necessary to store a great deal of access information. Also, for the sake of this discussion, no directory service is present from which the client can read server access information. Instead, the client must dynamically discover a server that provides the service it needs and learn how to access that server.

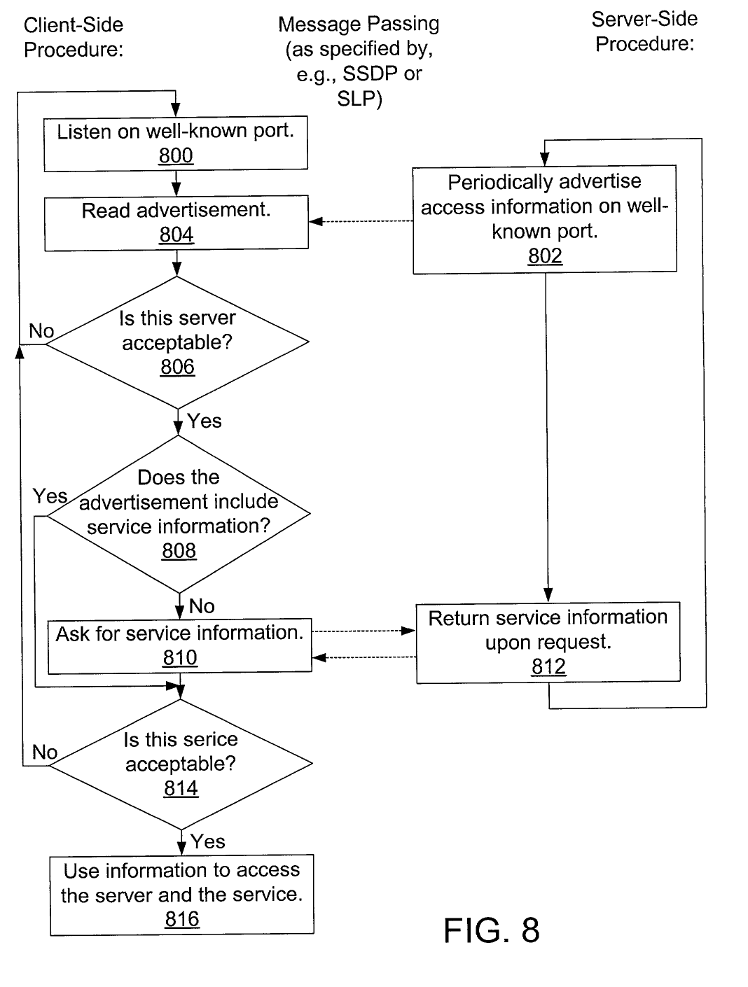

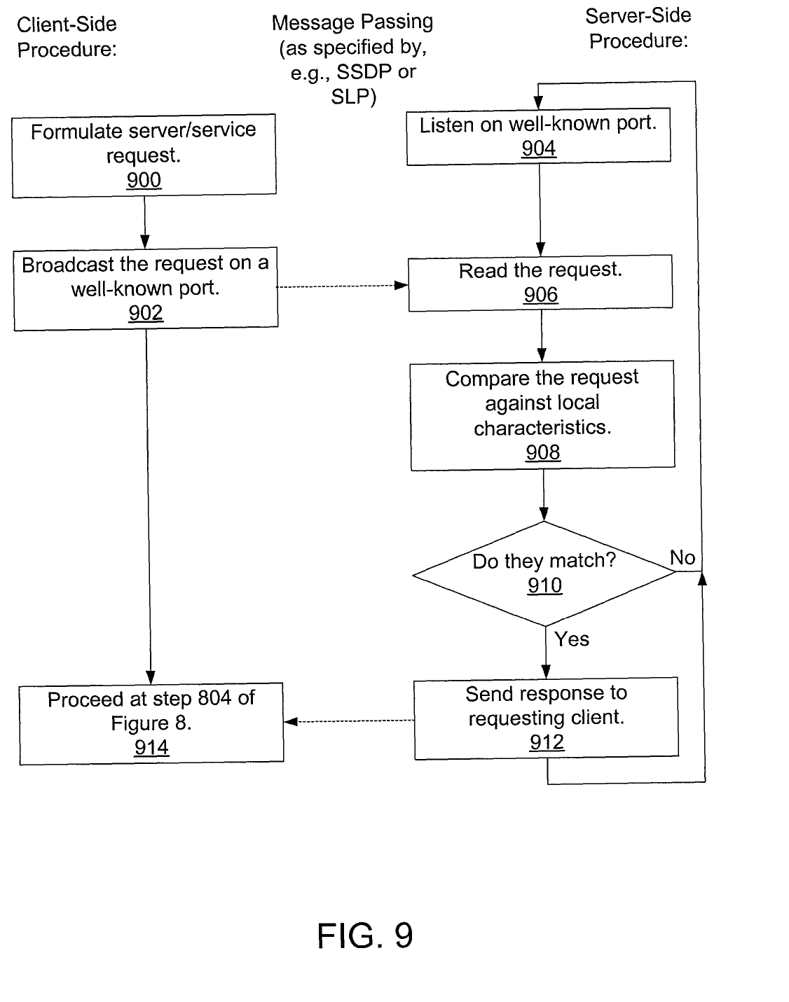

FIG. 8 is a flowchart illustrating an exemplary method the object-exchange client 100 may rely upon to discover object-exchange resources. In this method, the client listens on a well-known port provided by the network-routable communications protocol in step 800. The client listens for an advertisement from a server. A well-known port, such as port 650 in the IP transport 514 of FIG. 5, is a broadcast mechanism set up by prior arrangement and used by communicating devices to discover one another. Meanwhile, each server periodically sends an advertisement on the well-known port during step 802. The advertisement contains information about how to access the server and may contain further information, such as the services provided by the server. The format and content of advertisements are specified by such protocols as the Simple Service Discovery Protocol or the Service Location Protocol. During step 804, the client receives such an advertisement and checks to see if the server is acceptable in step 806. Reasons why the server may be unacceptable are described below with reference to FIGS. 7B through 7D. If the server is acceptable to the client, then in step 808 the client checks the advertisement to see if it contains information about the set of services provided by the server. If not, then the client requests service information from the server in step 810 and the server provides such information in step 812. If in step 814, the client finds the service information acceptable, then the client stores the access information and uses that information to access the server and the service in step 816. If either the server or the set of services is not acceptable to the client, then the client discards the information contained in the advertisement and resumes listening on the well-known port for a more acceptable alternative.

FIG. 9 is a flowchart illustrating another method used by a client to find an acceptable server and service. This method is typically used in conjunction with the advertisement method of FIG. 8 but is shown separately here for clarity's sake. In step 900, the object-exchange client 100 formulates a solicitation listing what it desires in a server and in a service. The solicitation message is broadcast on a well-known port in step 902. Object-exchange servers listen on the well-known port for such solicitations in step 904. In step 906, a server receives the solicitation and in step 908 compares the criteria in the solicitation with its own characteristics and with the characteristics of the services it provides. If a match is found in step 910, and if the server is otherwise ready to respond (that is, it is not overloaded by processing previous requests), then the server sends a response to the client in step 912. This response may be identical in form and content to the advertisement message sent during step 802 of FIG. 8. The message is directed to the specific address of the client or sent to the well-known port. The client receives the response in step 914 (which corresponds to step 804 of FIG. 8). The client proceeds to verify the suitability of the request (following the procedure in FIG. 8). If the response is not suitable or if no response is received, then the client may restart the procedure at step 900. As mentioned at the beginning of the description of this solicitation method, this method is typically used in conjunction with the advertisement method of FIG. 8. The client sends out solicitations and at the same time listens on a well-known port for unsolicited advertisements. Similarly, servers periodically send out unsolicited advertisements while listening for and responding to specific solicitations.

The text accompanying step 806 of FIG. 8 notes that some servers are unacceptable to the client. A server is not acceptable, by way of example, if it does not provide a service with the characteristics desired by the client. There are others reasons for rejections, however, based upon the fact that the client and server are running a network-routable protocol. Unlike the case with non-routed protocols (such as IrDA and Bluetooth), server advertisements and client solicitations on a routed network may travel far from their originator. The client may not want to accept services from a “too distant” server. There are several methods available to the client to limit the scope of acceptable servers. For example, the client may state that it is not interested in servers that exist beyond a router. In FIG. 7A, this restricts the scope of acceptable servers to the first server 104. Alternatively, the client states that servers only one “hop” (one transfer across a router) are acceptable. This adds the second server 106 to the scope of acceptability.

FIG. 7B adds IP addresses to the client and servers of FIG. 7A. The client may restrict the scope of acceptability to those servers whose addresses have a certain form, for example, addresses that match a mask “1.x.x.x” wherein “x” specifies that the client does not care what value occupies this place. The first (104), second (106), and fourth (708) servers match this criterion.

FIG. 7C shows another method of limiting the scope. The client and servers have each been given a Globally Unique Identifier (GUID). A GUID is not an address, but is simply a value shared with no other device in the world. The client records the GUID of a server that gave it acceptable service and requests service from that server again.

Finally, FIG. 7D adds physical location information. A client may only want service from servers physically or network topologically near to it. On the other hand, the client may preferentially desire service from a server near to a known location, such as in Tokyo. These methods of restricting the scope of acceptability are meant for illustration only. Other methods are possible and are considered to be within the scope of the present invention.

All of the references cited herein, including patents, patent applications, and publications, are hereby incorporated in their entirety by reference.

In view of the many possible embodiments to which the principles of this invention may be applied, it should be recognized that the embodiments described herein with respect to the drawing figures are meant to be illustrative only and should not be taken as limiting the scope of invention. The invention may be practiced on non-“WINDOWS” machines and on different kinds of communications links, including wireless and wired networks. Therefore, the invention as described herein contemplates all such embodiments as may come within the scope of the following claims and equivalents thereof.

We claim:

1. A method for an object-exchange client to discover an accessible object-exchange resource on a network incorporating routable communications protocols, the method comprising:
listening on a multicast channel provided according to a routable network communications protocol for an object-exchange resource identification advertisement;
receiving at least one advertisement on the multicast channel identifying an accessible object-exchange resource;
storing information from the received advertisement; and
using the stored information to access the identified object-exchange resource.

2. The method of claim 1 wherein the multicast channel is carried on a well-known port provided according to the routable network communications protocol.

3. The method of claim 1 wherein the received object-exchange resource identification advertisement is carried according to a protocol in the set consisting of: the Simple Service Discovery Protocol and the Service Location Protocol.

4. The method of claim 1 wherein the received object-exchange resource identification advertisement contains information expressed according to an extensible markup language definition.

5. The method of claim 1 wherein the identified accessible object-exchange resource is in the group: an object-exchange server, an object-exchange service, and a second object-exchange client.

6. The method of claim 5 wherein the identified accessible object-exchange resource is an object-exchange server and the received object-exchange resource identification advertisement lists object-exchange services provided by the object-exchange server.

7. The method of claim 5 wherein the identified accessible object-exchange resource is an object-exchange service in the group: inbox service, file browser, and synchronization service.

8. The method of claim 1 further comprising:
applying a filter to the at least one received advertisement and discarding advertisements that do not satisfy criteria of the filter.

9. The method of claim 8 wherein at least one criterion of the filter is in the group: Globally Unique Identifier, geographical location, network hop count from the identified accessible object-exchange resource to the object-exchange client, address mask, and domain name.

10. The method of claim 1 further comprising:
making a list of the identified accessible object-exchange resources.

11. The method of claim 1 further comprising:
formulating a discovery request asking object-exchange resources to identify themselves; and
sending the discovery request over the multicast channel.

12. The method of claim 11 wherein the discovery request specifies a property desired in responsive object-exchange resources.

13. The method of claim 12 wherein the desired property is expressed according to an extensible markup language definition.

14. The method of claim 11 wherein the scope of dispersal of the discovery request is expanded by bridging the discovery request from one network to another network.

15. The method of claim 11 wherein the scope of dispersal of the discovery request is limited by means of a network hop count.

16. A computer-readable medium containing instructions for performing a method for an object-exchange client to discover an accessible object-exchange resource on a network incorporating routable communications protocols, the method comprising:
listening on a multicast channel provided according to a routable network communications protocol for an object-exchange resource identification advertisement;
receiving at least one advertisement on the multicast channel identifying an accessible object-exchange resource;
storing information from the received advertisement; and
using the stored information to access the identified object-exchange resource.

17. A method for an object-exchange resource to make its accessibility known, the method comprising:
formulating an object-exchange resource identification advertisement; and
sending the advertisement on a multicast channel provided according to a routable network communications protocol.

18. The method of claim 17 wherein the multicast channel is carried on a well-known port provided according to the routable network communications protocol.

19. The method of claim 17 wherein the object-exchange resource identification advertisement is carried according to a protocol in the set: the Simple Service Discovery Protocol, the Service Location Protocol.

20. The method of claim 17 wherein the object-exchange resource identification advertisement contains information expressed according to an extensible markup language definition.

21. The method of claim 17 wherein the object-exchange resource is in the group: an object-exchange server, an object-exchange service, an object-exchange client.

22. The method of claim 21 wherein the object-exchange resource is an object-exchange server and the object-exchange resource identification advertisement lists object-exchange services provided by the object-exchange server.

23. The method of claim 21 wherein the object-exchange resource is an object-exchange service in the group: inbox service, file browser, and synchronization service.

24. The method of claim 17 further comprising:
listening on the multicast channel for a discovery request asking object-exchange resources to identify themselves; and
sending an object-exchange resource identification advertisement in response to a received discovery request.

25. A computer-readable medium containing instructions for performing a method for an object-exchange resource to make its accessibility known, the method comprising:
formulating an object-exchange resource identification advertisement; and
sending the advertisement on a multicast channel provided according to a routable network communications protocol.
